(19) United States
(12) Patent Application Publication
(10) Pub. No.: US 2024/0176327 A1
(43) Pub. Date: May 30, 2024

(54) MULTI-MODEL PREDICTIVE CONTROL METHOD FOR PICHIA PASTORIS FERMENTATION PROCESS

(71) Applicant: JIANGSU UNIVERSITY, Zhenjiang (CN)

(72) Inventors: Bo WANG, Zhenjiang (CN); Mengyi HE, Zhenjiang (CN); Xianglin ZHU, Zhenjiang (CN); Xingyu WANG, Zhenjiang (CN)

(21) Appl. No.: 18/430,722

(22) Filed: Feb. 2, 2024

Related U.S. Application Data
(63) Continuation of application No. PCT/CN2022/136801, filed on Dec. 6, 2022.

(30) Foreign Application Priority Data
Jan. 19, 2022 (CN) 202210061081.0

(51) Int. Cl. G05B 19/4155

(52) U.S. Cl. CPC G05B 19/4155; G05B 2219/42058

(57) ABSTRACT

Disclosed is a multi-model predictive control method for a Pichia pastoris fermentation process, including: dividing prior data into m training sample clusters by using a fuzzy C-means algorithm (FCM); obtaining, for each sample cluster, a corresponding prediction model by using a least squares support vector machine (LSSVM) and an improved particle swarm optimization method (IPSO); then, designing a corresponding predictive controller; and finally, calculating a deviation between an output of an object and an output of each sub-prediction model at each sampling time to establish a multi-model fusion predictive controller. According to the method, the adaptive ability of the model is improved and an actual state of a nonlinear system is described more accurately.

### CROSS-REFERENCE TO RELATED APPLICATIONS

This application is a continuation of PCT/CN2022/136801, filed Dec. 6, 2022 and claims priority of Chinese Patent Application No. 202210061081.0, filed on Jan. 19, 2022, the entire contents of which are incorporated herein by reference.

### TECHNICAL FIELD

The present disclosure relates to the technical field of biological fermentation, in particular to a multi-model predictive control method for a Pichia pastoris fermentation process.

### BACKGROUND

Protease K belongs to serine protease, which has high enzyme activity and wide substrate specificity. Protease K can be preferentially classified into hydrophobic amino acids, sulfur-containing amino acids, aromatic amino acids, C-terminal adjacent ester bonds, and peptide bonds, typically used to degrade proteins to produce short peptides. According to the properties, protease K has important applications in nucleic acid purification, silk, medicine, food, brewing and other fields. Pichia pastoris is a methanol nutritional yeast with methanol as a sole carbon source and energy source, which is the most widely applied exogenous protein expression system at present. Compared with other existing expression systems, Pichia pastoris has obvious advantages in processing, exocrine, post-translation modification and glycosylation modification of expression products, and has been widely applied in the expression of exogenous proteins. Protease K produced by Pichia pastoris fermentation will be an important step to break through the high expression of the protease. However, the Pichia pastoris fermentation process is a highly nonlinear and strongly coupled system, in which it is difficult to establish an accurate mathematical model. Meanwhile, the fermentation process has a strong time-varying characteristic, that is, a dynamic characteristic of the process varies with a fermentation time or batch. However, the traditional proportional-integral-derivative (PID) control and the modern control method based on a dynamic model are difficult to achieve good control results. Solving the above problems is the main task of Pichia pastoris fermentation process control.

Model predictive control (MPC) is a control method designed for nonlinear industrial processes, which adopts multi-step prediction, rolling optimization and feedback correction control strategies. MPC has the advantages of good control effect, strong robustness and low accuracy requirements of model. The advantages of MPC determine that the method can be effectively applied to the control of complex industrial processes, and has been successfully applied to the process systems of petroleum, chemical, metallurgical, mechanical and other industrial departments. Although MPC has strong robustness and is suitable for large-scale time delay system, the control effect is not ideal when MPC is applied to Pichia pastoris fermentation process with strong non-linearity and mutation of parameters with working conditions. Even if the feedback correction strategy is adopted, the influence of model mismatch cannot be weakened, thus affecting the steady and dynamic performance of fermentation process.

### SUMMARY

An example of the present disclosure provides a multi-model predictive control method for a Pichia pastoris fermentation process, including:
acquiring a concentration of protease K produced by Pichia pastoris fermentation;
clustering the concentration of protease K produced by Pichia pastoris fermentation by using a fuzzy C-means algorithm (FCM), and acquiring m sample clusters;
inputting each sample cluster into a least squares support vector machine (LSSVM) for training, and optimizing key parameters of LSSVM by using the improved particle swarm optimization (IPSO), and establishing m optimal sub-prediction models FCM-IPSO-LSSVM₁-FCM-IPSO-LSSVMₘ;
designing a corresponding model predictive controller for each optimal sub-prediction model;
acquiring a current state of a system;
calculating an output of the m optimal sub-prediction models and a mean-square error (MSE) Rᵢ(k) of controlled objects;
calculating a weight w of each sub-model predictive controller according to the MSE Rᵢ(k);
weighting and summing m sub-model predictive controllers according to a weight wᵢ of m model predictive controllers, and obtaining a fusion controller as an object control input to construct a multi-model fusion predictive controller; and
controlling the Pichia pastoris fermentation process by applying the multi-model fusion predictive controller to a model predictive control algorithm.

Further, the FCM includes:
inputting the number of clusters C, a fuzzy weighted parameter m and an iteration stop condition δ;
initializing a cluster center Vᵢ⁰(i=1,2, . . . , C);
calculating uᵢⱼ(i=1,2 . . . , C, j=1,2, . . . , n),

$${u}_{ij} = \{ \begin{matrix}1 / {\sum }_{k = 1}^{C} {( \frac{{d}_{ij}}{{d}_{ik}} )}^{\frac{2}{m - 1}} , {d}_{ij} \neq 0 \\ 1 , {d}_{ij} = 0 , j = k \\ 0 , {d}_{ij} = 0 , j \neq k\end{matrix}$$

where C is the number of clusters, and d_{ij=∥x}_{ⱼ}₋ᵥ_{ᵢ}_{∥} is a Euclidean distance between a sample xⱼ and a center vᵢ;
calculating Vᵢ^{l}(i=1,2, . . . , C),

$${V}_{i} = \frac{{\sum }_{j = 1}^{n} {u}_{ij}^{m} {x}_{j}}{{\sum }_{j = 1}^{n} {u}_{ij}^{m}} , i = 1 , 2 , … , C$$

where C is the number of clusters, and uᵢⱼ is a degree of membership of the sample xⱼ to class i; and
stopping the iteration if ∥V¹−V⁰∥≤δ, and outputting a clustering result (V, U) according to an objective function minJₘ (U,V); and continuing to execute the above steps from calculating uᵢⱼ(i=1,2 . . . , C, j=1,2, . . . , n) if not,
the objective function minJₘ(U,V) comprising:

$$min {J}_{m} ( U , V ) = {\sum }_{j = 1}^{n} {\sum }_{i = 1}^{C} {u}_{ij}^{m} {d}_{i j}^{2}$$

$$s . t . \{ \begin{matrix}{\sum }_{k = 1}^{C} {u}_{ik} = 1 \\ {u}_{ik} ⊂ [ 0 , 1 ] \\ {\sum }_{i = 1}^{n} {u}_{ik} > 0\end{matrix}$$

where C is the number of clusters, uᵢⱼ is the degree of membership of the sample xⱼ to class i, Vᵢ is a primary cluster center, and dᵢⱼ=∥xⱼ−vᵢ∥ is the Euclidean distance between the sample xⱼ and the center vᵢ.

Further, the LSSVM includes:
optimization issues, including:

$$min J ( w , e ) = \frac{1}{2} {w}^{T} w + \frac{1}{2} γ {\sum }_{k = 1}^{N} {e}_{k}^{2}$$

$$s . t . {y}_{k} = {w}^{T} ϕ ( x ) + b + {e}_{k} k = 1 , 2 , … , N$$

where ϕ(x): Rⁿ→R^{nH} is a kernel space mapping function, w is a weight vector, eₖ is an error variable, a parameter b is a deviation value, and γ is a regularization parameter; and
assuming a kernel function K(xᵢ, xⱼ)=ϕ(xᵢ)^{T}ϕ(xⱼ), an expression of an LSSVM model including:

ƒ(x)=Σᵢ₌₁^{N}aᵢK(x, xᵢ)+b (6)
where aᵢ∈R is a Lagrange multiplier, and through comparative analysis on multiple types of functions, a radial basis function (RBF) is selected as a kernel function of the LSSVM having a kernel width expression, including:

$$K ( {x}_{i} , {x}_{j} ) = exp ( \frac{{‖ {x}_{i} - {x}_{j} ‖}^{2}}{2 {σ}^{2}} )$$

expressions of parameters a and b, including:

$$[ \begin{matrix}0 & {Q}^{T} \\ Q & Ω + I / μ\end{matrix} ] [ \begin{matrix}b \\ a\end{matrix} ] = [ \begin{matrix}0 \\ {1}_{v}\end{matrix} ]$$

where Q=[y₁, . . . , y_{N}]^{T}, α=[a₁, . . . , a_{N}]^{T}, 1ᵥ=[1, . . . , 1]^{T}, Ω is a kernel matrix, having an expression of Ω_{i,j}=yᵢyⱼφ(xᵢ)^{T}φ(xⱼ)=yᵢyⱼK(xᵢ, xⱼ).

Further, the IPSO includes the calculation formulas:
supposing that a dimension of a target search space is m, the number of particles in a particle swarm is G, a position of a particle i in an m-dimensional space is represented as a vector Xᵢ=(x_{i,1}, x_{i,2}, . . . , x_{i,m}), i=1,2, . . . , G, and a flight speed is represented as a vector Vᵢ=(v_{i,1}, v_{i,2}, . . . , v_{i,m}), i=1,2, . . . , G; after adjustment, a best position of the particle is represented as Pᵢ=(p_{i,1}, p_{i,2}, . . . , p_{i,m}), and finally a best position of a whole swarm is represented as g_{best}=(p_{g,1}, p_{g,2}, . . . , p_{g,m}); and in the k-round iteration process of IPSO, a state parameter adjustment formula of each particle in the particle swarm including:

$$\{ \begin{matrix}{v}_{i , m} = ω {v}_{i , m} + {c}_{1} {r}_{1} ( {p}_{i , m} - {x}_{i , m} ) + {c}_{2} {r}_{2} ( {p}_{g , m} - {x}_{i , m} ) \\ {x}_{i , m} = {x}_{i , m} + {v}_{i , m}\end{matrix}$$

where ω is an inertia weight factor, a ω value is generally (0.1, 0.9), and the suitability of the ω value seriously affects the optimization ability of the algorithm; c₁ and c₂ are acceleration coefficients for adjusting the influence of individual particle changes on the swarm; and r₁ and r₂ are random numbers set to avoid the algorithm falling into local optimum, ranging within (0, 1).

Further, the inertia weight factor w is dynamically adjusted by using an adaptive adjustment strategy, and a calculation formula includes:

$${ω}_{i} = \{ \begin{matrix}{ω}_{min} + \frac{( {ω}_{max} - {ω}_{min} ) \cdot ( {J}_{i} - {J}_{min} )}{{J}_{avg} - {J}_{min}} , {J}_{i} \leq {J}_{avg} \\ {ω}_{max} , {J}_{i} > {J}_{avg}\end{matrix}$$

where ωₘᵢₙ and Jₘᵢₙ are minimum and maximum values of the inertia weight, ωᵢ is a current inertia weight value of a particle individual, Jᵢ is a fitness value of a current particle individual, and Jᵢ and Jₘᵢₙ are minimum and average values of the fitness in the whole swarm.

Further, an optimal iteration number N and the acceleration coefficients c₁ and c₂ are determined by using a variable method, including:
obtaining an optimal iteration number value N, combined with the Pichia pastoris fermentation process and a fixed test acceleration coefficient and according to different iteration number values N; and
simulating groups of different values of c₁ and c₂ according to the optimal iteration number value N and combined with the Pichia pastoris fermentation process, to obtain the best simulated c₁ and c₂ values.

Further, the calculating an output of the m optimal sub-prediction models and a mean-square error (MSE) Rᵢ(k) of controlled objects includes:

$${R}_{i} ( k ) = \frac{1}{N} {{\sum }_{i = 1}^{N} [ {y}_{i} ( {k}_{j} ) - y ( {k}_{j} ) ]}^{2} i = 1 , 2 , … , m , j = 1 , 2 , … , N$$

where yᵢ(kⱼ) is an output of an i^{th} sub-prediction model at a time kⱼ, and y(kⱼ) is an output of the system at the time kⱼ.

Further, the calculating a weight wᵢ of each sub-model predictive controller according to the MSE Rᵢ(k) includes:

$${w}_{i}^{′} ( k ) = \frac{{e}^{\frac{- {R}_{i} ( k )}{{V}^{2}}} {w}_{i} ( k - 1 )}{{\sum }_{j = 1}^{m} {e}^{\frac{- {R}_{j} ( k )}{{V}^{2}}} {w}_{j} ( k - 1 )}$$

$${w}_{i}^{″} ( k ) = \{ \begin{matrix}{w}_{i}^{′} ( k ) & {w}_{i}^{′} ( k ) > δ \\ δ & {w}_{i}^{′} ( k ) \leq δ\end{matrix}$$

$${w}_{i} ( k ) = \frac{{[ {w}_{i}^{″} ( k ) ]}^{2}}{{{\sum }_{j = 1}^{m} [ {w}_{i}^{″} ( k ) ]}^{2}}$$

where V is a parameter controlling a convergence speed of a weight factor; and δ is a threshold value limiting the importance of information.

Further, a control input formula of an object includes:

$$u ( k ) = {\sum }_{i = 1}^{m} {w}_{i} ( k ) {u}_{i} ( k )$$

where u is a control variable; and uᵢ is an output value of an i^{th} sub-model predictive controller.

The Pichia pastoris fermentation process is controlled by applying the multi-model predictive controller to the model predictive control algorithm.

The example of the present disclosure provides a multi-model predictive control method for a Pichia pastoris fermentation process. Compared with the prior art, the present disclosure has the following beneficial effects.

Herein, a weighted algorithm based on a relative error (soft-switching) is provided to design the multi-model fusion controller. The simulation results of Pichia pastoris fermentation process show that the algorithm can improve the transient response and achieve good output tracking.

### BRIEF DESCRIPTION OF THE DRAWINGS

FIG. 1 is a framework showing a multi-model predictive control method for a Pichia pastoris fermentation process according to an example of the present disclosure;

FIG. 2a is a graph showing simulation results of the fermentation process using the multi-model predictive control method for Pichia pastoris fermentation process according to an example of the present disclosure under acceleration coefficients c₁=2.0, c₂=2.0 and iteration times N=100;

FIG. 2b is a graph showing simulation results of the fermentation process using the multi-model predictive control method for Pichia pastoris fermentation process according to an example of the present disclosure under acceleration coefficients c₁=2.0, c₂=2.0 and iteration times N=100;

FIG. 2c is a graph showing simulation results of the fermentation process using the multi-model predictive control method for Pichia pastoris fermentation process according to an example of the present disclosure under acceleration coefficients c₁=2.0, c₂=2.0 and iteration times N=200;

FIG. 2d is a graph showing simulation results of the fermentation process using the multi-model predictive control method for Pichia pastoris fermentation process according to an example of the present disclosure under acceleration coefficients c₁=2.0, c₂=2.0 and iteration times N=200;

FIG. 2e is a graph showing simulation results of the fermentation process using the multi-model predictive control method for Pichia pastoris fermentation process according to an example of the present disclosure under acceleration coefficients c₁=2.0, c₂=2.0 and iteration times N=500;

FIG. 2f is a graph showing simulation results of the fermentation process using the multi-model predictive control method for Pichia pastoris fermentation process according to an example of the present disclosure under acceleration coefficients c₁=2.0, c₂=2.0 and iteration times N=500;

FIG. 2g is a graph showing simulation results of the fermentation process using the multi-model predictive control method for Pichia pastoris fermentation process according to an example of the present disclosure under acceleration coefficients c₁=2.0, c₂=2.0 and iteration times N=1000;

FIG. 2h is a graph showing simulation results of the fermentation process using the multi-model predictive control method for Pichia pastoris fermentation process according to an example of the present disclosure under acceleration coefficients c₁=2.0, c₂=2.0 and iteration times N=1000;

FIG. 3a is a graph showing simulation results of the fermentation process using the multi-model predictive control method for Pichia pastoris fermentation process according to an example of the present disclosure under N value of 200 and acceleration coefficients c₁=1.5, c₂=1.7;

FIG. 3b is a graph showing simulation results of the fermentation process using the multi-model predictive control method for Pichia pastoris fermentation process according to an example of the present disclosure under N value of 200 and acceleration coefficients c₁=1.5, c₂=1.7;

FIG. 3c is a graph showing simulation results of the fermentation process using the multi-model predictive control method for Pichia pastoris fermentation process according to an example of the present disclosure under N value of 200 and acceleration coefficients c₁=2.0, c₂=2.0;

FIG. 3d is a graph showing simulation results of the fermentation process using the multi-model predictive control method for Pichia pastoris fermentation process according to an example of the present disclosure under N value of 200 and acceleration coefficients c₁=2.0, c₂=2.0;

FIG. 3e is a graph showing simulation results of the fermentation process using the multi-model predictive control method for Pichia pastoris fermentation process according to an example of the present disclosure under N value of 200 and acceleration coefficients c₁=1.7, c₂=1.5;

FIG. 3f is a graph showing simulation results of the fermentation process using the multi-model predictive control method for Pichia pastoris fermentation process according to an example of the present disclosure under N value of 200 and acceleration coefficients c₁=1.7, c₂=1.5;

FIG. 4 is a multi-model modeling algorithm flow based on FCM-IPSO-LSSVM of the multi-model predictive control method for a Pichia pastoris fermentation process according to an example of the present disclosure;

FIG. 5 is a flow chart of a relative error weighting algorithm of the multi-model predictive control method for a Pichia pastoris fermentation process according to an example of the present disclosure;

FIG. 6a is a tracking response of a cell concentration P of a single model control method for a Pichia pastoris fermentation process according to an example of the present disclosure;

FIG. 6b is a tracking response of a cell concentration P of a model fusion control method for a Pichia pastoris fermentation process according to an example of the present disclosure.

FIG. 7a is a tracking response of protease K concentration of a single model control method for a Pichia pastoris fermentation process according to an example of the present disclosure; and

FIG. 7b is a tracking response of protease K concentration of a model fusion control method for a Pichia pastoris fermentation process according to an example of the present disclosure.

### DETAILED DESCRIPTION

Technical solutions in the examples of the present disclosure will be described clearly and completely in the following with reference to the attached drawings in the examples of the present disclosure. Obviously, all the described examples are only some, rather than all examples of the present disclosure. Based on the examples in the present disclosure, all other examples obtained by those of ordinary skill in the art without creative efforts belong to the scope of protection of the present disclosure.

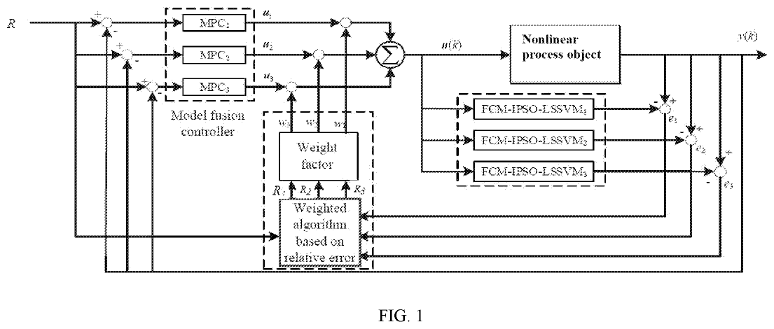

Referring to FIGS. 1-5, an example of the present disclosure provides a multi-model predictive control method for a Pichia pastoris fermentation process, including the following steps.

### At 1.1: Multi-Model Modeling based on FCM-IPSO-LSSVM

A basic idea of multi-model predictive control is to divide a nonlinear space of a controlled object into several subspaces. Then, a local model is established in each subspace, and a corresponding predictive controller is designed for each local model. The dynamic characteristics of the controlled object are approximated by multiple models in real time. Finally, the optimal control effect can be obtained by switching to an optimal sub-controller or by weighted summation of outputs of a plurality of sub-controllers.

The present disclosure provides a multi-model predictive control strategy based on a weighted algorithm. The prior data is divided into m training sample sets (sample clusters) by using FCM. For each sample cluster, a corresponding prediction model is obtained by using LSSVM and IPSO. Then, for m local prediction models (FCM-IPSO-LSSVM₁-FCM-IPSO-LSSVMₘ), the corresponding predictive controllers (MPC₁-MPCₘ) are designed. Finally, the deviation between the output of the object and the output of each sub-prediction model is calculated at each sampling time. Based on multi-model relative error weighted algorithm, a prediction model control strategy is established to optimize the control of the object. In the method, the transient performance of the system is improved by m local models, and the controlled variable can track a given value quickly. At the same time, the control strategy of real-time prediction model is constructed by the weighted algorithm based on a relative error, which improves the adaptive ability of the model and an actual state of a nonlinear system is described more accurately.

### At 1.1.1: FCM

In a given data set X={x₁, x₂, . . . , xₙ}, n is the number of samples. By FCM, the data set X is divided into C(2≤C≤n) classes.

An objective function of FCM is as follows:

$$min {J}_{m} ( U , V ) = {\sum }_{j = 1}^{n} {\sum }_{i = 1}^{C} {u}_{ij}^{m} {d}_{i j}^{2} \qquad ( 1 )$$

$$s . t . \{ \begin{matrix}{\sum }_{k = 1}^{C} {u}_{ik} = 1 \\ {u}_{ik} ⊂ [ 0 , 1 ] \\ {\sum }_{i = 1}^{n} {u}_{ik} > 0\end{matrix}$$

where C is the number of clusters, uᵢⱼ is the degree of membership of the sample xⱼ to class i, Vᵢ is a primary cluster center, and dᵢⱼ=∥xⱼ−vᵢ∥ is the Euclidean distance between the sample xⱼ and the center vᵢ.

The objective function minJₘ(U,V), Vᵢ and a degree of membership matrix U are calculated by the following equations:

$${V}_{i} = \frac{{\sum }_{j = 1}^{n} {u}_{ij}^{m} {x}_{j}}{{\sum }_{j = 1}^{n} {u}_{ij}^{m}} , i = 1 , 2 , … , C \qquad ( 2 )$$

$${u}_{ij} = \{ \begin{matrix}1 / {\sum }_{k = 1}^{C} {( \frac{{d}_{ij}}{{d}_{ik}} )}^{\frac{2}{m - 1}} , {d}_{ij} \neq 0 \\ 1 , {d}_{ij} = 0 , j = k \\ 0 , {d}_{ij} = 0 , j \neq k\end{matrix} \qquad ( 3 )$$

The specific processes of FCM are as follows.

At step 1: the number of clusters C, a fuzzy weighted parameter m and an iteration stop condition δ are inputted.

At step 2: a cluster center Vᵢ⁰(i=1,2, . . . , C) is initialized.

At step 3: uᵢⱼ(i=1,2 . . . , C, j=1,2, . . . , n) is calculated by using the equation (3).

At step 4: Vᵢ^{l}(i=1,2, . . . , C) is calculated by using the equation (2).

At step 5: the iteration is stopped if ∥V^{l}−V⁰∥≤δ, and step 6 is skipped to; and step 3 is skipped to if not.

At step 6: a clustering result (V, U) is outputted.

### At 1.1.2: LSSVM

Optimization issues of LSSVM are as follows:

$$min J ( w , e ) = \frac{1}{2} {W}^{T} W + \frac{1}{2} γ {\sum }_{k = 1}^{N} {e}_{k}^{2} \qquad ( 4 )$$

$$s . t . {y}_{k} = {w}^{T} ϕ ( x ) + b + {e}_{k} k = 1 , 2 , … , N \qquad ( 5 )$$

where ϕ(x): Rⁿ→R^{nH} is a kernel space mapping function, w is a weight vector, eₖ is an error variable, a parameter b is a deviation value, and γ is a regularization parameter; and assuming a kernel function K(xᵢ, xⱼ)=ϕ(xᵢ)^{T}ϕ(xⱼ), an LSSVM model can finally be expressed as:

ƒ(x)=Σᵢ₌₁^{N}aᵢK(x, xᵢ)+b (6)
where aᵢ∈R is a Lagrange multiplier, and through comparative analysis on multiple types of functions, an RBF function is selected as a kernel function of the LSSVM having a kernel width expression:

$$K ( {x}_{i} , {x}_{j} ) = exp ( \frac{{‖ {x}_{i} - {x}_{j} ‖}^{2}}{2 {σ}^{2}} ) \qquad ( 7 )$$

expressions of parameters a and b are as follows:

$$[ \begin{matrix}0 & {Q}^{T} \\ Q & Ω + I / μ\end{matrix} ] [ \begin{matrix}b \\ a\end{matrix} ] = [ \begin{matrix}0 \\ {1}_{v}\end{matrix} ] \qquad ( 8 )$$

where Q=[y₁, . . . , y_{N}]^{T}, α=[a₁, . . . , a_{N}]^{T}, 1ᵥ=[1, . . . , 1]^{T}, Ω is a kernel matrix, having an expression of Ωᵢⱼ₌yᵢyⱼφ(xᵢ)^{T}φ(xⱼ)=yᵢyⱼK(xᵢ, xⱼ).

The prediction ability of LSSVM mainly depends on the regularization parameters and kernel width, which affects the fitting accuracy and generalization ability of the model, and directly determines the computation amount and execution efficiency of the model. At present, the commonly used selection methods are network search algorithm and genetic algorithm, the former has a large computation amount and poor real-time performance, while the latter is easy to fall into local minimum. Herein, the IPSO is provided to optimize the parameters of LSSVM model, and good quality of parameter optimization is obtained.

### At 1.1.3: IPSO

The IPSO is used to track and adjust the position and speed of each particle in the swarm to achieve the optimization effect of a whole swarm. It is supposed that a dimension of a target search space is m, the number of particles in a particle swarm is G, a position of a particle i in an m-dimensional space is represented as a vector Xᵢ=(x_{i,1}, x_{i,2}, . . . , x_{i,m}), i=1,2, . . . , G, and a flight speed is represented as a vector Vᵢ=(v_{i,1}, v_{i,2}, . . . , v_{i,m}), i=1,2, . . . , G; after adjustment, a best position of the particle is represented as Pᵢ=(p_{i,1}, p_{i,2}, . . . , p_{i,m}), and finally a best position of a whole swarm is represented as g_{best}=(p_{g,1}, p_{g,2}, . . . , p_{g,m}); and in the k-round iteration process of IPSO, a state parameter of each particle in the particle swarm is adjusted by Equation (9):

$$\{ \begin{matrix}{v}_{i , m} = ω {v}_{i , m} + {c}_{1} {r}_{1} ( {p}_{i , m} - {x}_{i , m} ) + {c}_{2} {r}_{2} ( {p}_{g , m} - {x}_{i , m} ) \\ {x}_{i , m} = {x}_{i , m} + {v}_{i , m}\end{matrix} \qquad ( 9 )$$

where ω is a weight factor, a ω value is generally (0. 1, 0.9), and the suitability of the ω value seriously affects the optimization ability of the algorithm; c₁ and c₂ are acceleration coefficients for adjusting the influence of individual particle changes on the swarm; and r₁ and r₂ are random numbers set to avoid the algorithm falling into local optimum, ranging within (0, 1).

The values of ω, c₁, and c₂ are typically obtained by examining historical data, which are periodically adjusted and updated, resulting in parameters that tend to lag behind changes in industrial processes. Therefore, herein, the adaptive adjustment strategy is adopted to dynamically adjust the inertia weight ω, and the fitness value Jᵢ of the current individual is compared with the average fitness value J_{avg} of the whole swarm.

If Jᵢ is better than the average fitness J_{avg}, the reduction of the inertia weight ω of the corresponding individual is smaller, which is easy to make it close to the optimal position; if Jᵢ is lower than J_{avg}, the inertia weight of the corresponding single particle will be greater, thus making its search range wider and closer to a better search area. The adaptive adjustment strategy of the inertia weight ω is expressed as follows:

$${ω}_{i} = \{ \begin{matrix}{ω}_{min} + \frac{( {ω}_{max} - {ω}_{min} ) \cdot ( {J}_{i} - {J}_{min} )}{{J}_{avg} - {J}_{min}} \\ {ω}_{max} , {J}_{i} > {J}_{avg}\end{matrix} , {J}_{i} \leq {J}_{avg} \qquad ( 10 )$$

where ωₘᵢₙ and Jₘᵢₙ are minimum and maximum values of the inertia weight, ωᵢ is a current inertia weight value of a particle individual, Jᵢ is a fitness value of a current particle individual, Jᵢ and Jₘᵢₙ are minimum and average values of the fitness in the whole swarm. In the above equation, the inertia weight value will automatically vary with the fitness value of the current particle individual.

If only ω is decreased, it is difficult for the particle swarm optimization (PSO) algorithm to jump out of the local trap, which is easy to converge to a local extreme point. In addition, the acceleration coefficients c₁ and c₂ also have important influence on the global and local optimization ability of PSO algorithm, and different scholars have different views on the value of acceleration coefficients. The present disclosure adopts a variable method to determine the optimal number of iterations N and acceleration coefficients c₁ and c₂.

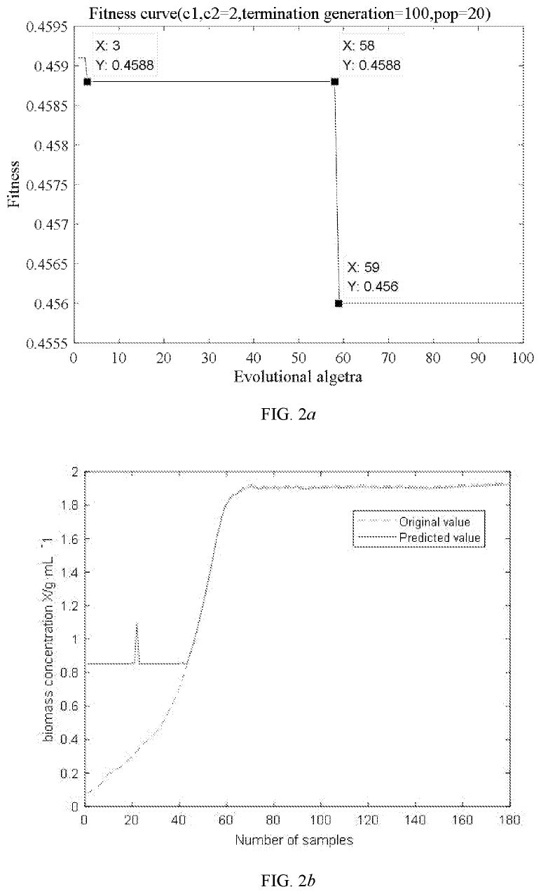

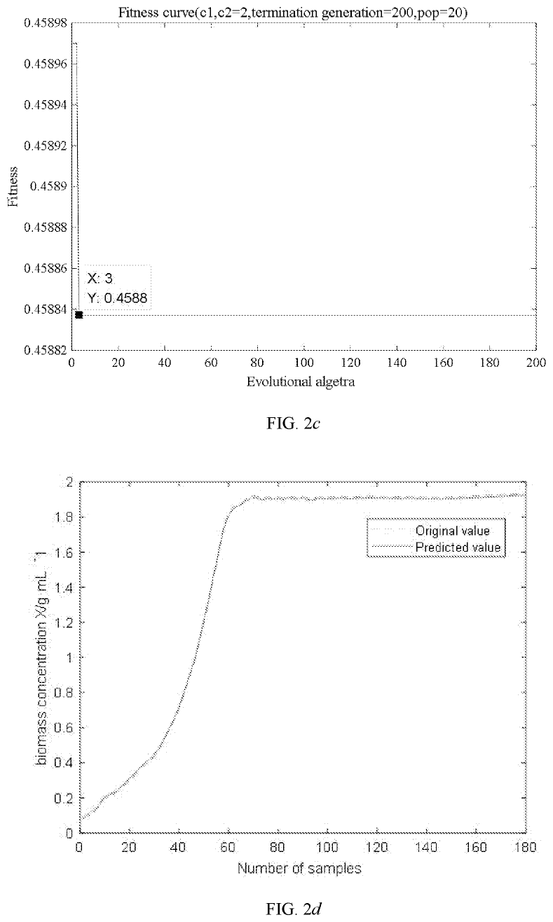

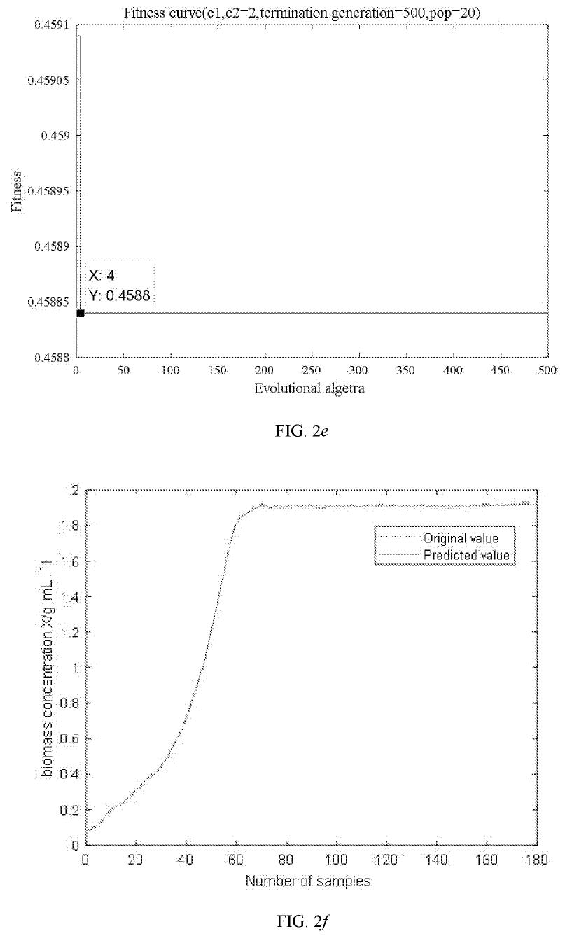

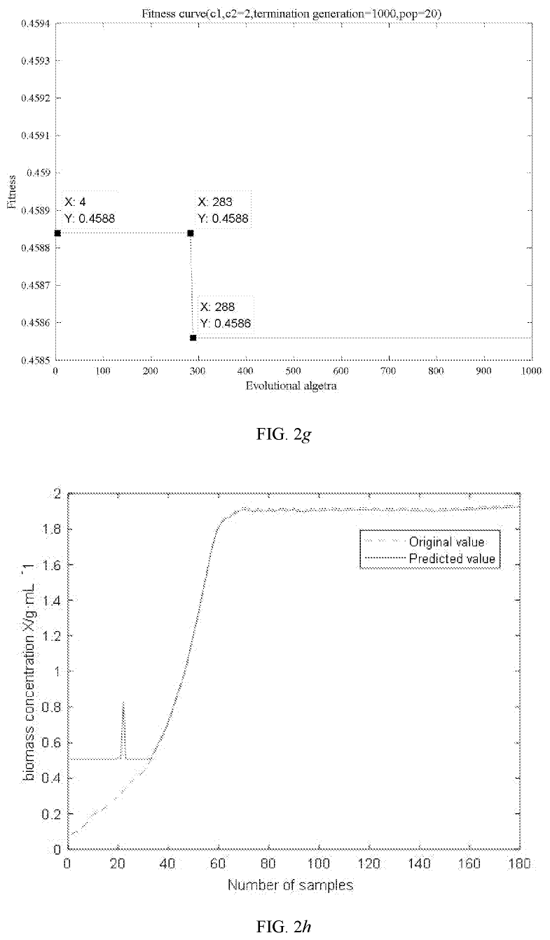

To explore the most appropriate value of N, i. e. the best number of iterations, combined with the Pichia pastoris fermentation process, the experimental acceleration coefficient c₁=c₂=2, and the N values are 100, 200, 500 and 1000. The simulation results of FIGS. 1a-1h differ from that of Nat this value. It can be seen from FIG. 2 that the simulation effect is best when N is 200.

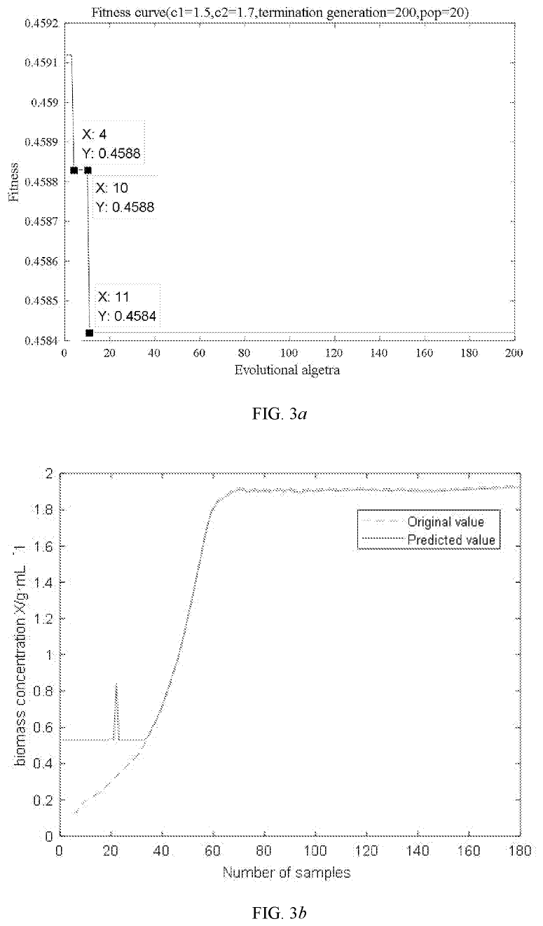

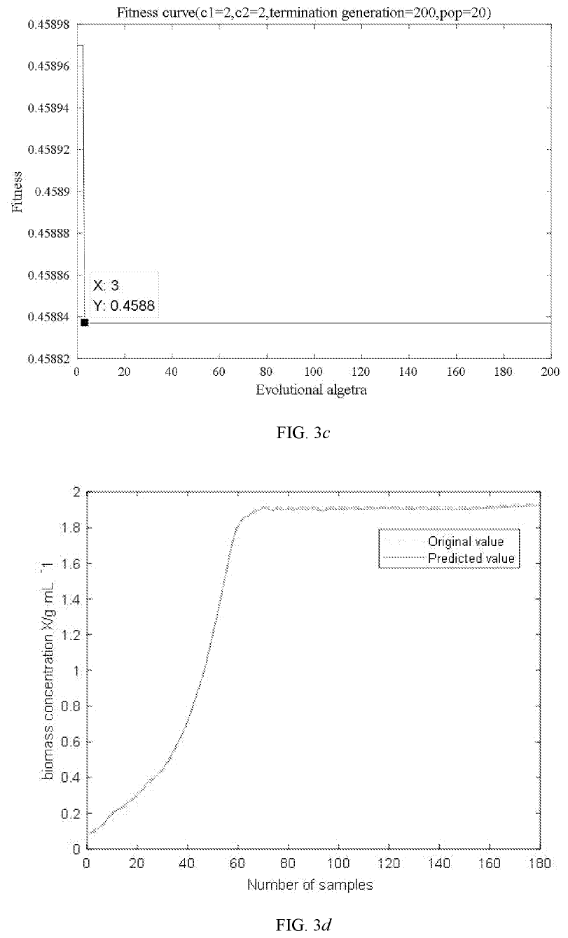

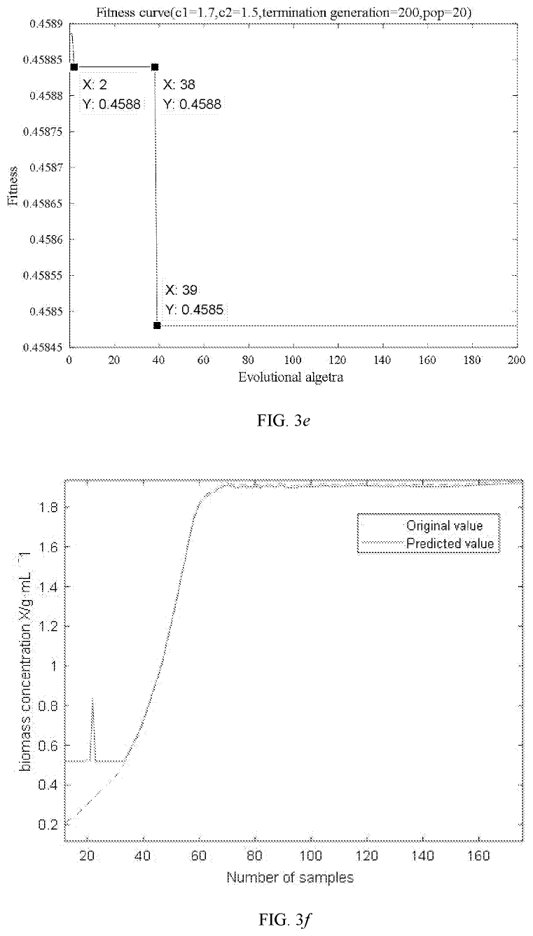

To explore the most appropriate values of acceleration coefficients c₁ and c₂, the value of N is set as 200. Combined with the Pichia pastoris fermentation process, c₁ and c₂ are divided into three groups of different values to simulate: (1) c₁=1.5, c₂=1.7; (2) c₁=c₂=2; and (3) c₁=1.7, c₂=1.5. The simulation results of c₁ and c2 are shown in FIG. 2a-2f. It can be seen from FIG. 3a-3f that the simulation effect is best when an acceleration coefficient is set as c₁=c₂=2.

In view of the above analysis, the study adopts adaptive adjustment strategy to dynamically adjust w, which not only effectively improves the global search ability and improves the convergence speed in the initial stage of the algorithm, but also ensures the local search performance in the later stage and improves the convergence accuracy of the algorithm. At the same time, the optimal iteration time N and acceleration coefficients c₁ and c₂ are determined by the variable method, which has significantly improved the optimization of key parameters of LSSVM.

### At 1.1.4: Multi-Model Modeling Algorithm

The flow chart of the multi-model modeling algorithm based on FCM-IPSO-LSSVM is shown in FIG. 3, and the specific steps are as follows.

At step 1: prior sample data is collected, the number of cluster centers m is given, and the prior sample data is preprocessed according to Equation (11) to reduce the adverse influence of the data range being too large or too small on the training process.

x*=(x−xₘᵢₙ)/(xₘₐₓ−xₘᵢₙ) (11)
where x is original data of a previous sample, and xₘₐₓ and xₘᵢₙ are upper and lower bounds.

At step 2: a degree of membership matrix is calculated according to Equation (3).

At step 3: an objective function Jₘ is calculated; if Jₘ<R, where R is a threshold value, the calculation is stopped, a final cluster center C and a fuzzy degree of membership matrix U are obtained, and step 5 is proceeded to; and otherwise, step 4 is proceeded to.

At step 4: the cluster center Vi is recalculated according to Equation (2).

At step 5: the samples belong to the category according to k-nearest neighbor discriminant method, and the training set of LSSVM is selected to eliminate abnormal prior samples.

At step 6: each class of training samples is inputted into LSSVM for training, an optimal key parameter of LSSVM is found by IPSO, and an optimal sub-prediction model is established.

The research of multi-model predictive control algorithm is mainly to design a predictive controller in advance for each local model. Then, the optimal sub-prediction model can be controlled by switching an index switch to a corresponding controller. In the design of multi-model weighted controller, the nonlinear space of the controlled object is divided into several subspaces, a local model is established in each subspace, and a corresponding predictive controller is designed for each local model. Then, the output of each sub-controller is weighted according to the relative error to obtain the actual control output.

### At 1.2.1: System Structure

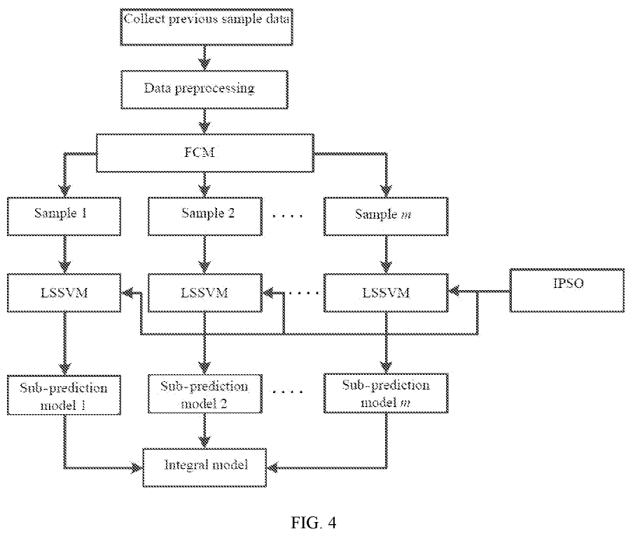

Taking three fixed system sub-prediction models as examples, the multi-model predictive control structure is shown in FIG. 4.

In FIG. 4, R is a reference track input, uᵢ is an output of an i^{th} sub-predictive controller, wᵢ is a weight of the i^{th} sub-predictive controller, u(k) is an output of a weighted controller, y(k) is an output of an actual system, and eᵢ is an output deviation between the output of the actual system and an output of an i^{th} prediction model. The multi-model modeling method based on FCM-IPSO-LSSVM introduced herein is used to obtain the prediction model of the system. Then, for each prediction model, the corresponding predictive controller is designed by using the multivariable generalized predictive control method. According to the matching degree of each prediction model with an actual object, a weighted weight of an actual nonlinear object is a weighted sum output by each controller.

### At 1.2.2: Weighted Algorithm based on Relative Error

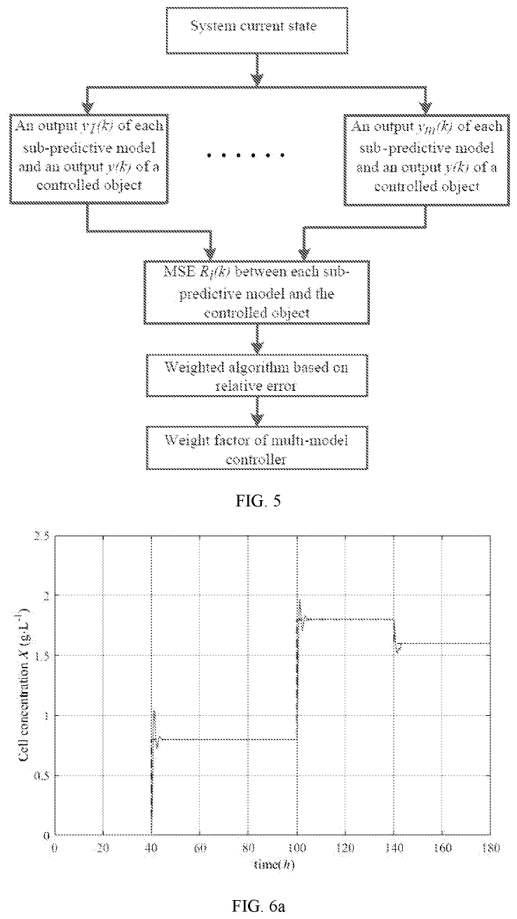

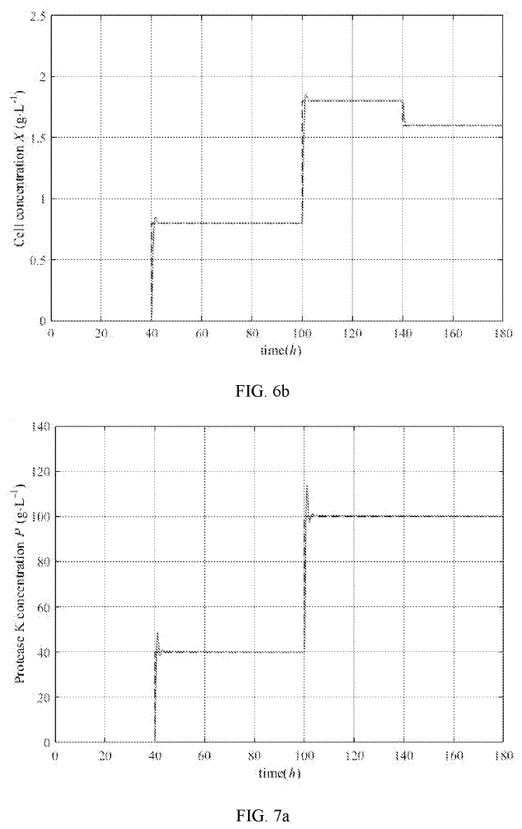

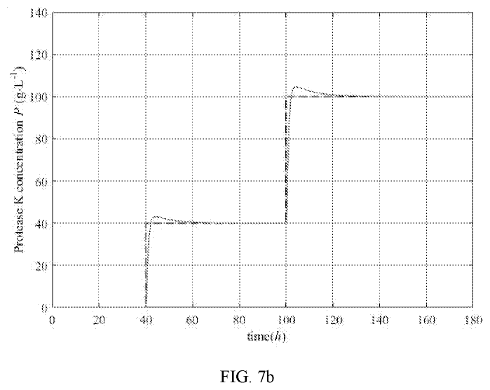

Herein, based on clustering modeling, a recursive method for weight factor convergence is provided by utilizing a relative error (k being a sampling time) between an output of each sub-prediction model yᵢ(k) and an output of a controlled system y(k). A block diagram of the algorithm is shown in FIG. 5.

The basic steps of the algorithm are as follows.

At step 1: system state data including a current system input, a last input and a last output is acquired.

At step 2: MSE Rᵢ(k) of the i^{th} sub-prediction model and object is defined as:

$${R}_{i} ( k ) = \frac{1}{N} {{\sum }_{j = 1}^{N} [ {y}_{i} ( {k}_{j} ) - y ( {k}_{j} ) ]}^{2} i = 1 , 2 , … , m , j = 1 , 2 , … , N \qquad ( 12 )$$

where yᵢ(kⱼ) is an output of the i^{th} sub-prediction model at a time kⱼ; and y(kⱼ) is an output of the system at the time kⱼ, a model with a minimum MSE being a matching model.

At step 3: a weight of an i^{th} predictive controller is obtained by the following equations:

$${w}_{i}^{′} ( k ) = \frac{{e}^{\frac{- {R}_{i} ( k )}{{V}^{2}}} {w}_{i} ( k - 1 )}{{\sum }_{j = 1}^{m} {e}^{\frac{- {R}_{j} ( k )}{{V}^{2}}} {w}_{j} ( k - 1 )} \qquad ( 13 )$$

$${w}_{i}^{″} ( k ) = \{ \begin{matrix}{w}_{i}^{′} ( k ) & {w}_{i}^{′} ( k ) > δ \\ δ & {w}_{i}^{′} ( k ) \leq δ\end{matrix} \qquad ( 14 )$$

$${w}_{i} ( k ) = \frac{{[ {w}_{i}^{″} ( k ) ]}^{2}}{{{\sum }_{j = 1}^{m} [ {w}_{i}^{″} ( k ) ]}^{2}} \qquad ( 15 )$$

where V is a parameter controlling a convergence speed of a weight factor; and δ is a threshold value limiting the importance of information.

At step 4: the control input of the object can be expressed as:

u(k)=Σᵢ₌₁^{m}wᵢ(k)uᵢ(k) (16)
where u is a control variable; and uᵢ is an output value of an i^{th} sub-predictive controller.

The present disclosure provides a weighted algorithm based on a relative error (soft-switching) to design the multi-model fusion controller, which improves the adaptive ability of the model and the actual state of the nonlinear system is described more accurately.

The method improves the transient performance of the system through multiple local models, so that the controlled variable can track the given value quickly. At the same time, the control strategy of real-time prediction model is constructed by the weighted algorithm based on a relative error, which improves the adaptive ability of the model and the actual state of the nonlinear system is described more accurately.

What has been disclosed above is only a few specific examples of the present disclosure, and various modifications and variations can be made to the examples of the present disclosure by those skilled in the art without departing from the spirit and scope of the present disclosure. However, the examples of the present disclosure are not limited thereto, and any variation that can be considered by those skilled in the art is to fall within the protection scope of the present disclosure.

1. A multi-model predictive control method for a Pichia pastoris fermentation process, comprising:
acquiring a concentration of protease K produced by Pichia pastoris fermentation;
clustering the concentration of protease K produced by Pichia pastoris fermentation by using a fuzzy C-means algorithm (FCM), and acquiring m sample clusters;
inputting each sample cluster into a least squares support vector machine (LSSVM) for training, and optimizing key parameters of LSSVM by using the improved particle swarm optimization (IPSO), and establishing m optimal sub-prediction models FCM-IPSO-LSSVM₁-FCM-IPSO-LSSVMₘ;
designing a corresponding model predictive controller for each optimal sub-prediction model;
acquiring a current state of a system;
calculating an output of the m optimal sub-prediction models and a mean-square error (MSE) Rᵢ(k) of controlled objects, and selecting an optimal sub-prediction model with a minimum MSE as a matching model;
calculating a weight wᵢ of each sub-model predictive controller according to the MSE Rᵢ(k);
weighting and summing m sub-model predictive controllers according to a weight wᵢ of m model predictive controllers, and taking a fusion controller as a control input to construct a multi-model fusion predictive controller; and
controlling the Pichia pastoris fermentation process by the multi-model fusion predictive controller.

2. The multi-model predictive control method for a Pichia pastoris fermentation process according to claim 1, wherein the FCM comprises:
inputting the number of clusters C, a fuzzy weighted parameter m and an iteration stop condition δ;
initializing a cluster center Vᵢ⁰(i=1,2, . . . , C);
calculating uᵢⱼ(i=1,2 . . . , C, j=1,2, . . . , n),
$${u}_{ij} = \{ \begin{matrix}1 / {\sum }_{k = 1}^{C} {( \frac{{d}_{ij}}{{d}_{ik}} )}^{\frac{2}{m - 1}} , {d}_{ij} \neq 0 \\ 0 , {d}_{ij} = 0 , j = k \\ 0 , {d}_{ij} = 0 , j \neq k\end{matrix}$$
where C is the number of clusters, and d_{ij=∥x}_{ⱼ}₋ᵥ_{ᵢ}_{∥} a Euclidean distance between a sample xⱼ and a center vᵢ;
calculating Vᵢ^{l}(i=1,2, . . . , C).
$${V}_{i} = \frac{{\sum }_{j = 1}^{n} {u}_{ij}^{m} {x}_{j}}{{\sum }_{j = 1}^{n} {u}_{ij}^{m}} , i = 1 , 2 , … , C$$
where C is the number of clusters, and uᵢⱼ is a degree of membership of the sample xⱼ to class i; and
stopping the iteration if ∥V^{l}−V⁰∥≤δ, and outputting a clustering result (V, U) according to an objective function minJₘ(U,V); and continuing to execute the above steps from calculating uᵢⱼ(i=1,2 . . . , C, j=1,2, . . . , n) if not,
the objective function minJₘ(U,V) comprising:
$$min {J}_{m} ( U , V ) = {\sum }_{j = 1}^{n} {\sum }_{i = 1}^{C} {u}_{ij}^{m} {d}_{ij}^{2}$$
$$s . t . \{ \begin{matrix}{\sum }_{i = 1}^{C} {u}_{ik} = 1 \\ {u}_{ik} ⊂ [ 0 , 1 ] \\ {\sum }_{i = 1}^{n} {u}_{ik} > 0\end{matrix}$$
where C is the number of clusters, uᵢⱼ is the degree of membership of the sample xⱼ to class i, Vᵢ is a primary cluster center, and dᵢⱼ=∥xⱼ−vᵢ∥ is the Euclidean distance between the sample xⱼ and the center vᵢ.

3. The multi-model predictive control method for a Pichia pastoris fermentation process according to claim 1, wherein the LSSVM comprises:
optimization issues, comprising:
$$min J ( w , e ) = \frac{1}{2} {w}^{T} w + \frac{1}{2} γ {\sum }_{k = 1}^{N} {e}_{k}^{2}$$
$$s . t . {y}_{k} = {w}^{T} ϕ ( x ) + b + {e}_{k} k = 1 , 2 , … , N$$
where ϕ(x): Rⁿ→R^{nH} is a kernel space mapping function, w is a weight vector, eₖ is an error variable, a parameter b is a deviation value, and γ is a regularization parameter; and
assuming a kernel function K(xᵢ, xⱼ)=ϕ(xᵢ)^{T}ϕ(xⱼ), an expression of an LSSVM model comprising:
ƒ(x)=Σᵢ₌₁^{N}aᵢK(x, xᵢ)+b (6)
where aᵢ∈R is a Lagrange multiplier, and through comparative analysis on multiple types of functions, a radial basis function (RBF) is selected as a kernel function of the LSSVM having a kernel width expression, comprising:
$$K ( {x}_{i} , {x}_{j} ) = exp ( \frac{{‖ {x}_{i} - {x}_{j} ‖}^{2}}{2 {σ}^{2}} )$$
expressions of parameters a and b, comprising:
$$[ \begin{matrix}0 & {Q}^{T} \\ Q & Ω + I / μ\end{matrix} ] [ \begin{matrix}b \\ a\end{matrix} ] = [ \begin{matrix}0 \\ {1}_{v}\end{matrix} ]$$
where Q=[y₁, . . . , y_{N}]^{T}, α=[a₁, . . . , a_{N}]^{T}, 1ᵥ=[1, . . . , 1]^{T}, Ω is a kernel matrix, having an expression of Ω_{i,j}=yᵢyⱼφ(xᵢ)^{T}φ(xⱼ)=yᵢyⱼK(xᵢ, xⱼ).

4. The multi-model predictive control method for a Pichia pastoris fermentation process according to claim 1, wherein the IPSO comprises the calculation formulas:
supposing that a dimension of a target search space is m, the number of particles in a particle swarm is G, a position of a particle i in an m-dimensional space is represented as a vector Xᵢ=(x_{i,1}, x_{i,2}, . . . , x_{i,m}), i=1,2, . . . , G, and a flight speed is represented as a vector Vᵢ=(v_{i,1}, v_{i,2}, . . . , v_{i,m}), i=1,2, . . . , G; after adjustment, a best position of the particle is represented as Pᵢ=(p_{i,1}, p_{i,2}, . . . , p_{i,m}), and finally a best position of a whole swarm is represented as g_{best}=(p_{g,1}, p_{g,2}, . . . , p_{g,m}); and in the k-round iteration process of IPSO, a state parameter adjustment formula of each particle in the particle swarm comprising:
$$\{ \begin{matrix}{v}_{i , m} = ω {v}_{i , m} + {c}_{1} {r}_{1} ( {p}_{i , m} - {x}_{i , m} ) + {c}_{2} {r}_{2} ( {p}_{g , m} - {x}_{i , m} ) \\ {x}_{i , m} = {x}_{i , m} + {v}_{i , m}\end{matrix}$$
where ω is an inertia weight factor, a ω value is generally (0. 1, 0.9), and the suitability of the ω value seriously affects the optimization ability of the algorithm; c₁ and c₂ are acceleration coefficients for adjusting the influence of individual particle changes on the swarm; and r₁ and r₂ are random numbers set to avoid the algorithm falling into local optimum, ranging within (0, 1).

5. The multi-model predictive control method for a Pichia pastoris fermentation process according to claim 4, wherein the inertia weight factor ω is dynamically adjusted by using an adaptive adjustment strategy, and a calculation formula comprises:
$${ω}_{i} = \{ \begin{matrix}{ω}_{min} + \frac{( {ω}_{max} - {ω}_{min} ) \cdot ( {J}_{i} - {J}_{min} )}{{J}_{avg} - {J}_{min}} \\ {ω}_{max} , {J}_{i} > {J}_{avg}\end{matrix} , {J}_{i} \leq {J}_{avg}$$
where ωₘᵢₙ and Jₘᵢₙ are minimum and maximum values of the inertia weight, ωᵢ is a current inertia weight value of a particle individual, Jᵢ is a fitness value of a current particle individual, and Jᵢ and Jₘᵢₙ are minimum and average values of the fitness in the whole swarm.

6. The multi-model predictive control method for a Pichia pastoris fermentation process according to claim 4, wherein an optimal iteration number N and the acceleration coefficients c₁ and c₂ are determined by using a variable method, comprising:
obtaining an optimal iteration number value N, combined with the Pichia pastoris fermentation process and a fixed test acceleration coefficient and according to different iteration number values N; and
simulating groups of different values of c₁ and c₂ according to the optimal iteration number value N and combined with the Pichia pastoris fermentation process, to obtain the best simulated c₁ and c₂ values.

7. The multi-model predictive control method for a Pichia pastoris fermentation process according to claim 1, wherein the calculating an output of the m optimal sub-prediction models and a mean-square error (MSE) Rᵢ(k) of controlled objects comprises:
$${R}_{i} ( k ) = \frac{1}{N} {{\sum }_{j = 1}^{N} [ {y}_{i} ( {k}_{j} ) - y ( {k}_{j} ) ]}^{2} i = 1 , 2 , … , m , j = 1 , 2 , … , N$$
where yᵢ(kⱼ) is an output of an i^{th} sub-prediction model at a time kⱼ, and y(kⱼ) is an output of the system at the time kⱼ.

8. The multi-model predictive control method for a Pichia pastoris fermentation process according to claim 1, wherein the calculating a weight wᵢ of each sub-model predictive controller according to the MSE Rᵢ(k) comprises:
$${w}_{i}^{′} ( k ) = \frac{{e}^{\frac{- {R}_{i} ( k )}{{V}^{2}}} {w}_{i} ( k - 1 )}{{\sum }_{j = 1}^{m} {e}^{\frac{- {R}_{j} ( k )}{{V}^{2}}} {w}_{j} ( k - 1 )}$$
$${w}_{i}^{″} ( k ) = \{ \begin{matrix}{w}_{i}^{′} ( k ) & {w}_{i}^{′} ( k ) > δ \\ δ & {w}_{i}^{′} ( k ) \leq δ\end{matrix}$$
$${w}_{i} ( k ) = \frac{{[ {w}_{i}^{″} ( k ) ]}^{2}}{{{\sum }_{j = 1}^{m} [ {w}_{i}^{″} ( k ) ]}^{2}}$$
where V is a parameter controlling a convergence speed of a weight factor; and δ is a threshold value limiting the importance of information.

9. The multi-model predictive control method for a Pichia pastoris fermentation process according to claim 1, wherein the control input is expressed as:
$$u ( k ) = {\sum }_{i = 1}^{m} {w}_{i} ( k ) {u}_{i} ( k )$$
where u is a control variable; and uᵢ is an output value of an i^{th} sub-model predictive controller.
